(19) United States
(12) Patent Application Publication
(10) Pub. No.: US 2021/0031967 A1
(43) Pub. Date: Feb. 4, 2021

(54) CONTAINER AND METHOD OF RESTRICTING THE OPENING OF A CONTAINER

(71) Applicant: PENTAGRAM DESIGNS LIMITED, London (GB)

(72) Inventor: Daniel WEIL, London (GB)

(21) Appl. No.: 16/526,653

(22) Filed: Jul. 30, 2019

(51) Int. Cl. B65D 5/06; B31B 50/00

(52) U.S. Cl. CPC B65D 5/061; B31B 50/0044

(57) ABSTRACT

A container, the container having a wall, the wall comprising a front panel and a rear panel spaced apart at opposing edges thereof by side parts attached by edge folds to the front and rear panels, each side part comprising front and rear gusset panels linked by a gusset fold, the front panel, rear panel and side parts each including a container portion and a closure portion, the container portions extending from a closed base of the container to the closure portion, the closure portions each including a rim defining an opening of the container, the container being arranged such that the gusset panels are located between the front and rear panels and can overlie one another, the container further comprising at least one locking corner defined in one of the front and rear panels and an associated gusset panel by locking folds which extend transverse to the edge fold from the intersection of the edge fold, the closure portion and the container portion to the rim, the locking corner being foldable such that the locking corner can be arranged between the front and rear gusset panels.

The present invention relates to a container, for example a bag or a box for shopping, and to a method of restricting the opening of a container.

Containers, such as bags and boxes, are commonly used for carrying items and come in many different shapes and sizes. Items are placed into the container through an opening. A large opening is convenient for placing items into the container, however, to reduce the risk of theft of the items, or to reduce their visibility, it is advisable to restrict the size of the opening after the items have been placed inside. This can be achieved in a number of ways, for example straps, catches or zips, but these may not be cost effective for some containers, such as disposable shopping containers. A known form of disposable shopping container is a side gusset bag made of paper or card and this may be supplied flat.

The present invention provides a container, the container having a wall, the wall comprising a front panel and a rear panel spaced apart at opposing edges thereof by side parts attached by edge folds to the front and rear panels, each side part comprising front and rear gusset panels linked by a gusset fold, the front panel, rear panel and side parts each including a container portion and a closure portion, the container portions extending from a closed base of the container to the closure portion, the closure portions each including a rim defining an opening of the container, the container being arranged such that the gusset panels are located between the front and rear panels and can overlie one another, the container further comprising at least one locking corner defined in one of the front and rear panels and an associated gusset panel by locking folds which extend transverse to the edge fold from the intersection of the edge fold, the closure portion and the container portion to the rim, the locking corner being foldable such that the locking corner can be arranged between the front and rear gusset panels.

By folding the locking corners so that they are located between the front and rear gusset panels the opening of the container can be restricted so that the contents of the container cannot be as easily seen or accessed as if the opening was not restricted. By restricted it is meant that the size of the opening of the container is made smaller, or prevented from as easily manipulated to make the opening wider.

The container may be any suitable size or shape. The wall of the container extends around a circumference of the container and is formed from a front panel and a rear panel. The front and rear panels may be substantially the same size and shape as one another, for example they may be substantially rectangular or square. Opposing edges of the front and rear panels are joined together, and spaced apart by, side parts. Each side part connects an edge of the front panel to an edge of the rear panel.

The side parts are coupled to the front and rear panels by edge folds. Where folds are mentioned in this description the folds may be unbiased folds, meaning that the container can be as readily folded in either direction along the fold, or the folds may be biased to preferentially, or more easily, fold in one direction. The edge folds may be biased to preferentially, or more easily, fold the side parts towards the inside of the container such that a peak of the fold extends towards the outside of the container.

The side parts comprise front and rear gusset panels connected by a gusset fold which may be biased or unbiased. The gusset fold may be biased such that the fold is directed towards the inside of the container. The front and rear gusset panels of each side part may be substantially the same size and shape as one another, for example they may be rectangular or square.

The container has a closed base. The closed base may be formed in any suitable way, for example with a seam, or by folding lower parts of the container to create, in use, a substantially flat base which may be any suitable shape, for example square or rectangular. The container portion of the panels may be connected to the base by a base fold. The creation of such bases is known in the art and will not be described in more detail here.

The container portion of the side parts and the front and rear panels extends from the base and typically provide the part of the wall that will surround any contents located in the container. In use the container parts will usually form a lower part of the container.

The container portions of the front and rear panels extends from the base to a closure portion. The closure portion includes a rim which defines the opening of the container. In use the closure portion will usually form an upper portion of the container. Since the closure portions carry the rim of the opening it may be the closure portions that are manipulated to restrict the opening of the container.

The container is arranged such that the gusset panels are located between the front and rear panels and can overlie one another. By overlie it is meant that major surfaces, which may be substantially flat, of the front and rear gusset panels are arranged adjacent one another and may be in contact. In this case the major surfaces are external surfaces. In such an arrangement the container may be substantially flat with the side parts sandwiched between the front and rear panels.

The container comprises at least one locking corner. A locking corner is a corner of the container adjacent the opening which can be manipulated into a position in which the opening of the container is restricted.

To define a locking corner locking folds are formed in one of the front and rear panels and an associated gusset panel. For the avoidance of doubt, a gusset panel is associated with the corner of the front or rear panel if it shares an edge fold. Locking folds may be biased or unbiased depending upon the intended opening restriction methods to be used.

The container may comprise at least two locking corners, a locking corner being defined in each of the front and rear panels and an associated gusset panel of one side part by locking folds which extend transverse to the edge fold from the intersection of the edge fold, the closure portion and the container portion to the rim, each locking corner being foldable such that each locking corner can be arranged between the front and rear gusset panels. By providing two locking corners associated with the same side part an improved restriction of the opening can be achieved at least on that side.

The container may comprise four locking corners, a locking corner defined in each of the front and rear panels and an associated gusset panel of each side part by locking folds which extend transverse to the edge fold from the intersection of the edge fold, the closure portion and the container portion to the rim, each locking corner being foldable such that each locking corner can be arranged between respective front and rear gusset panels. By providing four locking corners, one in each available corner of the opening of the container a further improvement of the restriction of the opening can be achieved.

A closure fold may be formed between the container portion and the closure portion of the side parts and/or between the container portion and the closure portion of the front and rear panels. This may assist with defining the closure portions of the panels and will also help them to move more independently of the container portions. Further, a closure fold between the container portion and the closure portion of the side parts may facilitate use of at least one closure method. A closure fold between the container portion and the closure portion of the front and rear panels may help with the creation of a box like container.

The locking corners associated with a common side part may be arranged such that a central region of the rim of the side part can be folded outwardly towards the container portion to form a beak, the beak being foldable about the closure fold such that the closure portion of the side part overlies a region of the container portion. This may allow the front and rear panel part of the locking corners to overlie regions of the closure portion of the front and rear panels if the container were to be flattened.

In this arrangement the beak can be folded downward between the gusset panels and this causes the front and rear panel part of the locking corners to overlie regions of the closure portion of the front and rear panels. In this configuration the beak is reverse folded and acts as a lock pulling the front and rear panels together such that the effective area of the opening is restricted.

The, or each, locking corner may be configured so that it can be arranged between the closure portions of the front and rear gusset panels and front and rear panels. This is achieved by folding the locking corner about the locking folds. In such an arrangement the closure folds overlie one another and so effectively lock the associated panels, the front panel and front gusset panel, or the rear panel and rear gusset panel, together at the fold. The locking corner is held in the folded configuration by the shape of the side parts.

The locking folds may extend at substantially 45° to the edge folds. The, or each, locking fold in a gusset panel may extend from the edge fold to the gusset fold. This arrangement means that the locking folds meet at the gusset fold and so provide for efficient restriction of the opening of the container.

The container may be made of any suitable material. The container may be made of any material which is stiff enough to have a fold pre-formed such that the above fold arrangements can be created. For example it may be made from paper, paperboard, card, or cartonboard materials. A relatively thin and/or relatively flexible material, such as a paper, could be used to create a container which may be considered to be a bag. A relatively thicker and/or relatively rigid material, such as a cartonboard or card, may be used to create a container that could be considered to be a box.

The material may be printed prior to the manufacture of the container, or after. The material may comprise a composite material, for example fabric covered material, or material covered in a waterproof film.

The container may include handles. A handle may be connected to each of the front panel and to the rear panel. The handles may be connected to the closing portions of those panels. The handles may be formed of a flexible tape, or twine. The tape may have a substantially flat cross section and may be, for example, a ribbon or webbing. The twine may be string, wool, rope or other flexible element with a substantially circular cross section. Such handles may be secured to the container by being passed through holes pierced or punched through the wall.

The closure portion of the front and rear panels may include a reinforced region to which the handles can be attached. The reinforced region may be formed by folding a reinforcing extension about the rim so that it overlies a region of the associated closure portion.

The closure portion of the front and rear panels may include one or more projection portions defined therein. The projection portions include a projection fold at one edge thereof and have a cut line extending from one end of the projection fold to the other such that the cut line and projection fold define the projection portion. The projection fold may allow the projection portion to be folded out of the plane of the closure portion of the front and rear panels. If the front and rear panels include a closure fold, the projection fold may be aligned with the closure fold.

The projection portion may be substantially rectangular, or may be any other shape that can be defined by the cut line. A projection portion may be located substantially centrally along a closure fold on each of the front and rear panels.

The projection portion may be folded into the container to provide a hole through which a user can insert their fingers to facilitate carrying or moving the container. The projection portion may be folded out of the plane of the closure portion, away from the container, so that the projection portions extend away from the container and can be grasped by a user to facilitate carrying or moving the container.

The container may include handles and/or projection portions/or may include neither.

While it has been stated that the front and rear panels may be substantially square or rectangular, it should be noted that it is possible for them to have other overall shapes. In particular the rim may not be linear and could be formed to include curves, ridges or other shapes.

In one embodiment the base of the container is substantially rectangular with a long edge that is at least twice as long as the short edge.

The invention extends to a method of closing a container, the container being as set out above and the method comprising the steps of:
a) folding the, or each, locking corner and arranging the, or each, locking corner between the associated front and rear gusset panels.

The invention further provides a method of closing a container, the container being as set out above and the method comprising the steps of:
a) folding a central region of the rim of the side part outwardly towards the container portion to form a beak;
b) folding the beak about the closure fold such that the closure portion of the side part overlies a region of the container portion and the front and rear panel part of the locking corners to overlie regions of the closure portion of the front and rear panels.

The invention also provides a method of closing a container, the container being as set out above and the method comprising the steps of:
a) folding the, or each, locking corner about the locking folds so that the locking corner is arranged between regions of the closure portions of the front and rear gusset panels and front and rear panels.

The invention also provides a blank for creating a container, the blank including pre-formed folds, including edge folds, gusset folds and locking folds such the blank can be formed into a container as described above.

The invention will now be described by way of example only.

A container, in this case a bag has a wall, in this case a circumferential wall. The wall comprises a front panel and a rear panel spaced apart at opposing edges thereof by side parts. The side parts are attached by edge folds to the front and rear panels. Each side part comprises front and rear gusset panels linked by a gusset fold.

In this case the bag is substantially rectangular in profile. The front and rear panels are substantially rectangular and are the same size and shape. The gusset panels are also all rectangular and substantially the same size and shape. This means that the bag is substantially symmetrical front to back and side to side, meaning that the construction of each corner of the bag is substantially identical.

The front panel, rear panel and side parts each include a container portion and a closure portion. The container portions extend from a closed base of the bag to the closure portion. The closure portions each include a rim defining an opening of the bag.

The bag is arranged such that the gusset panels are located between the front and rear panels and can overlie one another. The bag further comprises at least one locking corner, in this case it comprises four, defined in one of the front and rear panels and an associated gusset panel by locking folds which extend transverse to the edge fold from the intersection of the edge fold, the closure portion and the container portion to the rim. The locking corner is foldable such that the locking corner can be arranged between the front and rear gusset panels.

The closure portions of the front and rear panels include holes through which a handle can be secured to the bag, in this case the handle is passed through the holes and tied to create a knot that cannot pass back through the hole.

The bag also includes closure folds between the container portions of the side parts and the closure portions of the side parts and closure folds between the container portions of the front and rear panels and the closure portions of the front and rear panels. It should be understood that the closure folds in the front and rear panels need not be included for the closure locking of the bag to be functional. In fact, absence of the closure folds in the front and rear panels may enhance the locking action.

The front and rear panels are brought together near the rim. This causes the gusset folds to fold inwardly, thereby bringing the front and rear panels and the front and rear gusset panels closer together, particularly in the region of the locking corners.

The locking corners are folded into the side parts. This is achieved for each locking corner by pinching the elements of each locking corner together (one of the front and rear panel and the associated gusset panel) so that the locking folds of the locking corner align. This then enables the locking corner to be folded about the aligned locking folds towards the side parts.

The locking corners are folded into the side parts. Folding of the locking corners about the aligned closure folds by more than 90° acts to secure the front or rear panel to the associated gusset panel at the closure folds. The locking corners are effectively secured between the closure portions of the front and rear gusset panels. Since the front and rear panels are secured to the gusset panels along the closure folds the front and rear panels are biased to a position in which the opening of the bag is substantially closed.

The locking corners of the bag are folded to form a beak. The beak can be created by folding a region of the rim of the side part outwardly about the closure fold towards the container portion. This causes the edge folds of the locking corners to move inwardly.

The beak is folded down onto the side parts. Continuing to fold the region of the rim of the side part outwardly about the closure fold towards the container portion causes the edge fold of the locking corners to align with the closure fold of the gusset panels.

The beak is fully folded down. In this position the closure portion of the side part overlies a region of the container portion. The gusset fold in the closure portion of the side part is reverse folded so that it can lie along the gusset fold of the container portion of the side part. This reverse folding of a part of the gusset fold acts like an over-centre mechanism and help to secure the beak in place against the gusset fold.

If the bag were to be made flat in this configuration the front and rear panel part of the locking corners would overlie regions of the closure portion of the front and rear panels.

Since the beak is secured between the gusset panels in this configuration the size of the opening is restricted and the beaks must be flipped upwards to enable the opening to be freely opened.

Although described as a bag, the formation of a beak and the restriction of the opening creates a box like structure. This may be described as a box, particularly if fabricated from a relatively stiff material, like card or cardboard.

A blank for forming the bag is substantially rectangular with a tab at one side which can be glued or otherwise secure to the opposing side to create a hoop. In addition to the tab the blank comprises four main areas. From left to right is a front panel area, a first side part area, a rear panel area and a second side part area from which the tab extends. These areas are linked by edges folds. Each of the first and second side part areas are divided in half by gusset folds to define the gusset panels.

Each of the areas and the tab is divided into sub areas by horizontal fold lines. The fold lines may be formed, for example, by pressing, creasing or scoring. At the top is the closure portion and then the container portion separated from that by closure folds.

The container portion includes a base region which is defined by a base fold. Within the container portion, and above the base fold is a flattening fold which aides in the folding flat of the bag for storage or shipping.

The closure portion includes the rim which is defined by a rim fold. The rim fold allows the closure portion to be folded to create a double thickness region through which holes extend for receiving a handle.

Locking folds are formed in the closure portion of the front and rear panel areas and of the side part areas to define the locking corners. The locking folds extend at an angle of 45 degrees to the edge folds from the intersection of the edge fold and the closure folds to the rim and beyond.

Base forming folds extend at an angle of 45 degrees to the gusset folds from the intersection of the gusset fold and the flattening fold and extend in a direction away from the closure portion.

Projection portions are defined by a cut line and a projection fold. The projection portions are located substantially centrally along the closure fold of each of the front and rear panel areas. The projection portions can be folded into, or away from, the container, when formed, by folding along the projection fold. When the blank is used to form the container, in particular a box, the projection portions may be folded away from the container so that they project substantially parallel with the plane of the front and rear panel areas.

The folds may be biased or unbiased folds. In some cases such as the edge folds and base folds a biased fold may be more appropriate. For other folds, such as the gusset fold in the closure portion of the embodiment an unbiased fold may be more appropriate.

It should be understood that the embodiments given above are by way of example only and features can be modified within the scope of the claims. It should also be noted that through appropriate section of folds for a particular bag it is possible to use either opening restriction method.

1. A container, the container having a wall, the wall comprising a front panel and a rear panel spaced apart at opposing edges thereof by side parts attached by edge folds to the front and rear panels, each side part comprising front and rear gusset panels linked by a gusset fold, the front panel, rear panel and side parts each including a container portion and a closure portion, the container portions extending from a closed base of the container to the closure portion, the closure portions each including a rim defining an opening of the container, the container being arranged such that the gusset panels are located between the front and rear panels and can overlie one another, the container further comprising at least one locking corner defined in one of the front and rear panels and an associated gusset panel by locking folds which extend transverse to the edge fold from the intersection of the edge fold, the closure portion and the container portion to the rim, the locking corner being foldable such that the locking corner can be arranged between the front and rear gusset panels.

2. A container as claimed in claim 1, in which the container comprises at least two locking corners, a locking corner being defined in each of the front and rear panels and an associated gusset panel of one side part by locking folds which extend transverse to the edge fold from the intersection of the edge fold, the closure portion and the container portion to the rim, each locking corner being foldable such that each locking corner can be arranged between the front and rear gusset panels.

3. A container as claimed in claim 2, in which the container comprises four locking corners, a locking corner defined in each of the front and rear panels and an associated gusset panel of each side part by locking folds which extend transverse to the edge fold from the intersection of the edge fold, the closure portion and the container portion to the rim, each locking corner being foldable such that each locking corner can be arranged between respective front and rear gusset panels.

4. A container as claimed in claim 2, in which a closure fold is formed between the container portion and the closure portion of the side parts.

5. A container as claimed in claim 2, in which a closure fold is formed between the container portion and the closure portion of the front and rear panels.

6. A container as claimed in claim 4, in which the locking corners associated with a common side part are arranged such that a central region of the rim of the side part can be folded outwardly towards the container portion to form a beak, the beak being foldable about the closure fold such that the closure portion of the side part overlies a region of the container portion.

7. A container as claimed in claim 1, in which the, or each, locking corner can be arranged between the closure portions of the front and rear gusset panels and front and rear panels.

8. A container as claimed in claim 1, in which the locking folds extend at substantially 45° to the edge folds.

9. A container as claimed in claim 1, in which the, or each, locking fold in a gusset panel extends from the edge fold to the gusset fold.

10. A container as claimed in claim 1, in which the container is made from a paper, or paperboard material.

11. A container as claimed in claim 1, in which the container includes at least one projection portion defined in the closure portion of one of the front panel and rear panel.

12. A method of restricting the opening of a container, the container being as claimed in claim 1 and the method comprising the steps of:
a) folding the, or each, locking corner and arranging the, or each, locking corner between the associated front and rear gusset panels.

13. A method as claimed in claim 12, in which:
the container comprises at least two locking corners, a locking corner being defined in each of the front and rear panels and an associated gusset panel of one side part by locking folds which extend transverse to the edge fold from the intersection of the edge fold, the closure portion and the container portion to the rim, each locking corner being foldable such that each locking corner can be arranged between the front and rear gusset panels;
a closure fold is formed between the container portion and the closure portion of the side parts; and
the locking corners associated with a common side part are arranged such that a central region of the rim of the side part can be folded outwardly towards the container portion to form a beak, the beak being foldable about the closure fold such that the closure portion of the side part overlies a region of the container portion,
the method comprising the steps of:
a) folding a central region of the rim of the side part outwardly towards the container portion to form a beak;
b) folding the beak about the closure fold such that the closure portion of the side part overlies a region of the container portion.

14. A method as claimed in claim 12, in which the, or each, locking corner can be arranged between the closure portions of the front and rear gusset panels and front and rear panels and the method comprising the steps of:
a) folding the, or each, locking corner about the locking folds so that the locking corner is arranged between regions of the closure portions of the front and rear gusset panels and front and rear panels.

15. A blank for creating a container, the blank including pre-formed folds, including edge folds, gusset folds and locking folds such the blank can be formed into a container as claimed in claim 1.
